(19) United States
(12) Patent Application Publication
(10) Pub. No.: US 2024/0430794 A1
(43) Pub. Date: Dec. 26, 2024

(54) Sustainable Configuration Generation Based On Network Speed and Client Demand

(71) Applicant: Cisco Technology, Inc., San Jose, CA (US)

(72) Inventors: Clark A. Carty, Brunswick, OH (US); Dan Duckworth, Akron, OH (US); Kasi R. Nalamalapu, Pleasanton, CA (US); Jun Liu, Shanghai (CN); Ruifeng Xue, Shanghai (CN)

(21) Appl. No.: 18/341,637

(22) Filed: Jun. 26, 2023

(51) Int. Cl. H04W 52/02

(52) U.S. Cl. CPC H04W 52/0206

(57) ABSTRACT

Various methods, systems, and/or processes are described herein to create more sustainable configurations of wireless Access Points (APs), switches, and other network devices based upon network speed, client demand, among other factors. Clients may wirelessly couple to an AP using a variety of different technologies. The clients may be distributed over these frequency bands in an optimal manner allowing minimum use of transceiver power. The network link speed between the AP and the Ethernet switch may also be dynamically adjusted. These configurations may dynamically change over time as client demand or network traffic increases or decreases. In certain other configurations, the APs may have a higher wireless throughput than the ethernet connections to the network. In these instances, sustainable configurations can be achieved by powering down transceivers, radio chains, and/or processor cores. Traffic and other events may trigger the need for new sustainable configurations to be generated and applied.

The present disclosure relates to network devices. More particularly, the present disclosure relates to configuring access points based on both hardware and wireless throughput needs.

### BACKGROUND

Wireless networking has become ubiquitous in homes, businesses, and other locales. Client devices with wireless capability may connect to appliances known as a wireless Access Points (APs). In larger establishments like hotels, hospitals, restaurants, businesses, etc., multiple APs may be physically distributed around the area where wireless access is desired. The provisioning of these APs may be based on a desired level of service (sometimes referred to as a Service-Level Agreement or SLA).

In general, APs may be overprovisioned to ensure that the SLA requirements are met with little consideration of other issues. This can be wasteful at times when the bandwidth provided by the network of APs significantly exceeds the actual demand of the client devices present. In addition to costing the network owner more money supplying electricity to the wireless network, it is also not good for the environment to needlessly waste power.

Sustainability is becoming more of a requirement in many places and applications. It is highly desirable to find a method of controlling the APs in wireless networks that reduces power consumption to just the level it is needed at any given time. Allowances can also be made for choosing more or less sustainable sources of energy when multiple sources of energy are available.

### SUMMARY

Systems and methods for configuring access points based on both hardware and wireless throughput needs in accordance with embodiments of the disclosure are described herein. In some embodiments, a device, comprises a processor, a memory communicatively coupled to the processor, a network interface controller configured to be in communication with a network switch via an ethernet connection, a plurality of transceivers configured to provide wireless network access to a plurality of clients wherein each of the plurality of clients has an associated throughput, and a dynamic power saving logic. The dynamic power saving logic can be configured to determine an ethernet connection speed, adjust the plurality of device transceivers in response to the determined ethernet connection speed, inspect the client throughput for each of the plurality of clients, and compare the inspected client throughput against a first predetermined threshold. The logic may also be configured to shut down a transceiver, in response to the inspected client throughput being below the first predetermined threshold.

In some embodiments, the ethernet connection speed is a negotiated ethernet link speed between the device and the network switch.

In some embodiments, the dynamic power saving logic is further configured to: access a total speed of the plurality of transceivers, and compare the negotiated ethernet link speed against the total speed of the plurality of transceivers.

In some embodiments, the adjustment of the plurality of device transceivers includes powering down one or more of the transceivers in response to the negotiated ethernet link speed being less than the total speed of the plurality of transceivers.

In some embodiments, the adjustment of the plurality of device transceivers is also based on client preference data.

In some embodiments, the client preference data includes at least one preferred energy band of wireless network connection.

In some embodiments, determining the ethernet connection speed is based on at least the number of associated clients or the client throughput.

In some embodiments, the dynamic power saving logic is further configured to shut down a processor, in response to the inspected client throughput being below the first predetermined threshold.

In some embodiments, the first predetermined threshold is determined by accessing a look-up table.

In some embodiments, the look-up table contains a plurality of entries associated with the inspected client throughput.

In some embodiments, the plurality of entries within the look-up table has an associated number of processors to operate.

In some embodiments, the dynamic power saving logic is further configured to: monitor the plurality of clients being provided wireless network access, compare the monitored plurality of clients against a second predetermined threshold, and power on a transceiver, in response to the monitored plurality of clients exceeding the second predetermined threshold.

In some embodiments, a method of sustainably managing an access point comprises determining an ethernet connection speed between the access point and a network switch connected to the access point via an ethernet connection, adjusting a plurality of device transceivers associate with the access point in response to the determined ethernet connection speed, determining a plurality of clients connected to the access point, and inspecting a client throughput for each of the plurality of clients. The method may also comprise comparing the inspected client throughput against a first predetermined threshold, and adjusting a transceiver, in response to the inspected client throughput being below the first predetermined threshold.

In some embodiments, a device comprises a processor, a memory communicatively coupled to the processor, a network interface controller configured to be in communication with a network switch via an ethernet connection, a plurality of device transceivers configured to provide wireless network access to a plurality of clients across one or more frequency bands and wherein each of the plurality of clients has an associated throughput. The device can comprise a dynamic power saving logic configured to determine an ethernet connection speed, adjust the plurality of device transceivers in response to the determined ethernet connection speed, inspect the client throughput for each of the plurality of clients on one or more of the frequency bands, and adjust the plurality of transceivers based on the inspected client throughput across the one or more frequency bands.

In some embodiments, the adjustment of the plurality of transceivers includes powering off the frequency band in response to each of the inspected plurality of clients not utilizing the frequency band.

In some embodiments, the dynamic power saving logic is further configured to: access client preference data associated with the frequency band, and retain power to the frequency band based on the accessed client preference data.

In some embodiments, the dynamic power saving logic is further configured to: steer one or more clients associated with the frequency band toward a different frequency band, and power off the frequency band in response to the steering of the associated clients being completed.

In some embodiments, the dynamic power saving logic is further configured to: access client preference data associated with the frequency band, and retain power to the frequency band based on the accessed client preference data.

In some embodiments, the steering of the one or more clients associated with the frequency band occurs in response to a number of clients associated with the frequency band is below a third predetermined threshold.

In some embodiments, the steering of the one or more clients occurs across a second device, such that the frequency band of the one or more clients is retained when steered to the second device.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic diagram of a network 100 with network devices powered by various power source types in accordance with various embodiments of the disclosure;

FIG. 2 is a conceptual illustration of a network in accordance with various embodiments of the disclosure;

FIG. 3A is a conceptual illustration of a floorplan with a plurality of access points in accordance with various embodiments of the disclosure;

FIG. 3B is a conceptual illustration of a floorplan with a reduced power configuration applied to the plurality of access points in accordance with various embodiments of the disclosure;

FIG. 4 is a conceptual illustration of a floorplan with a plurality of access points in accordance with various embodiments of the disclosure;

FIG. 5 is a flowchart depicting a process for access point configuration based upon network link speed and client loading in accordance with various embodiments of the disclosure;

FIG. 6 is a flowchart depicting a process for access point configuration based upon network link speed and client loading in accordance with various embodiments of the disclosure;

FIG. 7 is a flowchart depicting a process for access point configuration based upon network link speed and client loading in accordance with various embodiments of the disclosure;

FIG. 8 is a flowchart depicting a process for access point configuration based upon network link speed and client loading in accordance with various embodiments of the disclosure;

FIG. 9 is a flowchart depicting a process for access point configuration based upon network link speed and client loading in accordance with various embodiments of the disclosure; and

FIG. 10 is a conceptual block diagram of a device suitable for use in a transceiver energization system in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, devices and methods are discussed herein that determine and apply sustainable configurations on access points within a network. In many embodiments, the access points can have a plurality of inputs. In certain embodiments, customer preferences can be utilized such that certain transceivers or USB power may be preferred to be turned off, when possible, etc. In some embodiments, the power level available may be switched (such as between 802.3at and 802.3bt) in certain configurations. In more embodiments, various hardware settings can be adjusted within the access point to be more sustainable. For example, one or more cores within a processor may be powered down. In more examples, radio chains may also be powered down. Over time, the network can be monitored, and new sustainable configurations can be determined and applied in response to new events, traffic, or other changes.

In a variety of embodiments, the access points may be configured such that the ethernet connection provided can only supply a certain throughput, even though the transceivers within the access point can be capable of much faster throughput if it were available. As such, in these embodiments, the access points can be configured sustainability such that one or more transceivers can be powered down in order to match throughputs between the wired side of the access point and the wireless side of the access point. In this way, no extra energy is utilized, and a more sustainable configuration can be achieved.

As will be described in more detail below, various methods, such as, but not limited to, lookup tables can be utilized that can correspond certain current states within the access point or network with a certain sustainable state. Based on one or more events, triggers, and/or thresholds, various sustainable actions can occur. Each access point may be individually configured as well, either statically or dynamically by a network administrator via a set of heuristics or one or more machine learning processes. In this way, client preferences can be taken into account in addition to the current network and/or access point conditions when making sustainable configurations and changes.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

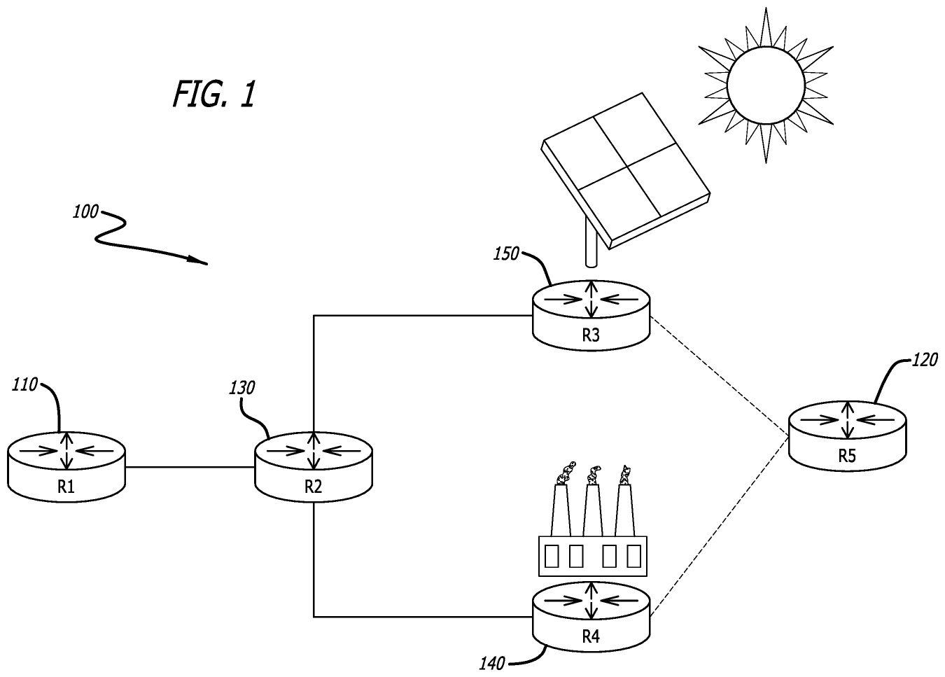

Referring to FIG. 1, a schematic diagram of a network 100 with network devices powered by various power source types in accordance with an embodiment of the disclosure is shown. The network 100 can include a plurality of devices, e.g., routers 110, 130, 140 and 150, which can be in communication with each other and/or a remote server, such as a cloud-based server 120. The network 100 depicted in FIG. 1 is shown as a simplified, conceptual network. Those skilled in the art will understand that a network 100 can include a large variety of devices and may be arranged in a virtually limitless number of combinations based on the desired application and available deployment environment.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Traditionally, devices operating within a network 100 have not considered various aspects of operation that can relate to the overall sustainability of the network. For example, devices in communication networks have often used grid-supplied energy as a primary power source. This grid-supplied energy can regularly provide energy that has been generated by a negative environmental impacts-heavy power source such as a coal-powered power plant. However, modern power grids often have more diverse and cleaner energy sources for the provided generated energy. Some devices can still be powered by power sources that utilize fossil fuels, such as the router R4 140 as depicted in FIG. 1. Alternatively, some devices can operate by using renewable sources of energy, such as the router R3 150 which is conceptually depicted as being powered by solar power.

Those skilled in the art will recognize that the generation of electricity within the various power plants often creates some pollution or, more generally, one or more negative environmental impacts, which can often come in the form of emissions. However, these negative environmental impacts can come in a variety of forms including, but not limited to, land use, ozone depletion, ozone formation inhibition, acidification, eutrophication (freshwater, marine, and terrestrial), abiotic resource depletion (minerals, metals, and fossil fuels), toxicity, water use, negative soil quality change, ionizing radiation, hazardous waste creation, etc. As such, these negative environmental impact measurements can be measured with specific units to quantify these changes. Various aspects of energy use can be associated with one or more of these negative environmental impacts and classified as one or more sustainability-related attributes.

In the embodiment depicted in FIG. 1, the operation of a coal-powered power plant will create a sizeable amount of negative environmental impacts in the form of carbon emissions and the like. Contrast that with a solar array which may not create emissions when generating electricity, but may negative environmental impacts, such as carbon emission generation, associated with the production and/or disposal of the solar array. Various methods of measuring these negative environmental impacts may occur. One measurement may be to examine the waste products created by the power generated (such as nuclear waste, vs. solar array e-waste, etc.).

Another measurement of negative environmental impacts that can be utilized when comparing power sources is to determine the amount of greenhouse or carbon emissions released per unit of electricity generated. Specifically, various embodiments described herein may utilize the CO₂e kg/kWh metric which measure the amount of kilowatt hours produced per kilogram of carbon dioxide gases released into the environment. Therefore, when discussing a negative environmental impacts-heavy power source compared to a clean(er) power source, the clean power source can, for example, have a better CO₂e kg/kWh rating compared to the negative environmental impacts-heavy power source. Utilizing a cleaner power source thus provides for a more sustainable network operation.

In order the maximize the overall sustainability of a network, it may be desirable to increase the use of cleaner power sources with a lower overall negative environmental impact as opposed to power sources with a higher overall negative environmental impact when operating the network. Thus, there can be a need to be aware of the source of energy provided at each device along the route of data travel. Additionally, other factors such as the attributes unique to each device can be factored in, along with the current and/or expected traffic, etc. Once known, an optimal method of traversing the data may need to be calculated. As discussed in more detail, this path algorithm can be utilized to better optimize the locations selected within a network for data travel.

Other methods may be utilized to increase sustainability in network operations. In many embodiments, the network devices themselves may have one or more features or other capabilities that can allow for a more efficient operation. For example, a network router may be operated in a lower power mode or be powered off entirely for a specific period of time or until an event occurs. Additional embodiments may utilize various other power-saving capabilities that can be turned on or off remotely or in response to an event or predetermined threshold being exceeded. Often, operations performed by the network devices can be utilized in scenarios where network performance will not be affected or is affected such that no loss in user experience occurs. By utilizing less power during operation, a higher level of sustainability can be achieved.

Together, the type of power source providing electricity to a network device, along with the various sustainability-related capabilities of the router can be understood as the sustainability-related attributes of that network device. During operation, one or more devices within the network may seek and collect the sustainability-related attributes of various network devices, which can provide insight into both the type of power source providing power to the device, but also the various capabilities of the network device that may be activated to provide more efficient operation.

Additionally, when generating various scores, metrics, or other evaluations of the network devices within a network 100, the sustainability-related attributes can vary based on a variety of factors such as the time of day, current network traffic, expected network traffic, and historical usage patterns. For example, a network router may receive energy from a solar power source during the day but receives energy from a coal-powered power plant at night. In these instances, an averaged score may be used, or a unique score may be generated at the time of operation. In another example, network traffic may be such that removing one or more network devices from the optimal sustainable data paths may negatively affect user experiences, such as when a sporting event occurs. As such, scores may be generated at numerous times depending on the desired application. Often, the act of measurement may negatively affect sustainability such that determining the proper amount of measurements for a given outcome may be determined.

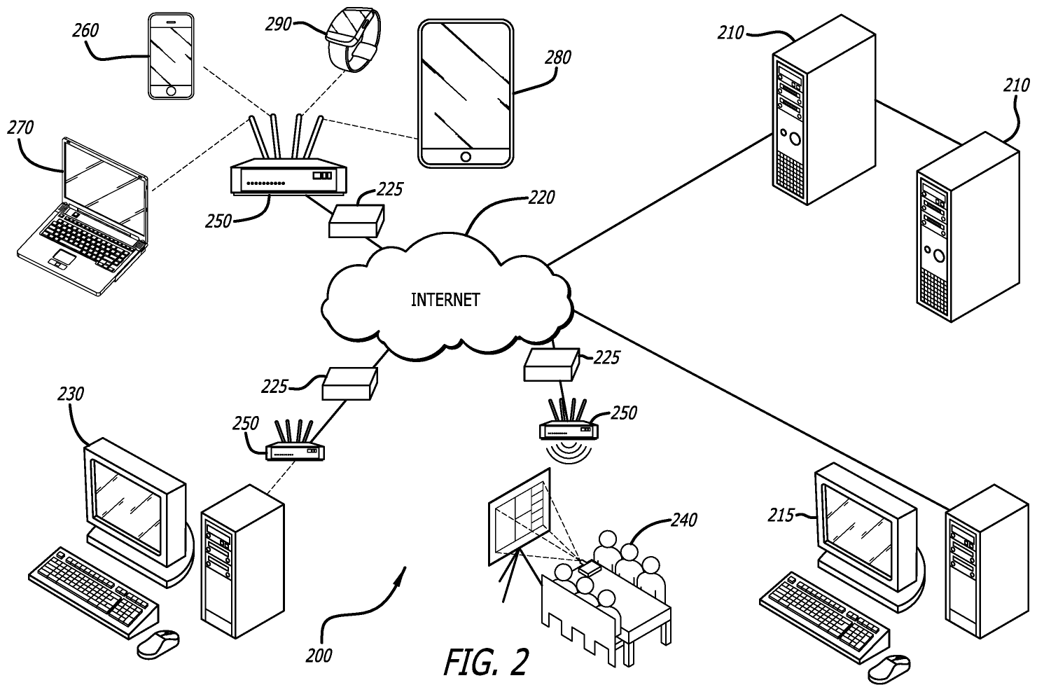

Although a specific embodiment for a network 100 is described above with respect to FIG. 1, any of a variety of systems and/or processes may be utilized in accordance with embodiments of the disclosure. For example, the network could be broken into a plurality of partitions, wherein each partition could have specific needs, service level agreements, etc. that can alter sustainability-optimization. The elements depicted in FIG. 1 may also be interchangeable with other elements of FIGS. 2-10 as required to realize a particularly desired embodiment. Augmented protocols to carry out these described processes are described below.

Referring to FIG. 2, a conceptual illustration of a network 200 in accordance with various embodiments of the disclosure is shown. Network 200 may comprise a plurality of servers 210 coupled to an administrator console 215 via the Internet 220. The servers may contain various sorts of data that can be accessed from the administrator console 215 and other devices coupled to the Internet 220. In many embodiments, the servers 210 and administrator console 215 may be hard-wired to the Internet 220 using a technology such as Ethernet. The speed of various Ethernet connections may vary depending on the hardware available at each end of the connection. In a number of embodiments, optical or wireless or other types of connections may be used.

Client computer 230 may be coupled with the Internet 220 through a wireless Access Point (AP) 250 coupled to an Ethernet switch 225. The AP may comprise a network interface controller to communicate with the Ethernet switch. AP 250 may typically comprise one or more device transceivers to support one or more different wireless technologies like, but not limited to, Wi-Fi communicating at 2.4 Gigahertz (GHz), 5.0 GHz, and/or 6.0 GHz, Bluetooth, cellular technologies like 3G, 4G, and 5G, etc., to support wireless network access. Client computer 230 may have an antenna (not shown in the figure) that is coupled with a transceiver. This transceiver may wirelessly couple with antennas and transceivers in wireless AP 250.

Wireless AP 250 may be coupled with an Ethernet cable to Ethernet switch 225. The Ethernet connection speed may be negotiated between AP 250 and Ethernet switch 225. In a variety of embodiments, the speed may be determined by the throughput of the connection with client computer 230 and any other wireless clients coupled to AP 250. Transceivers in AP 250 may be turned completely on or off or put into a state where they may operate with reduced power and reduced bandwidth. Sometimes transceiver/antenna pairs are also referred to as radios. The bandwidth of these radios may be divided into portions called chains, and only some of the chains may be operated in various times in a variety of embodiments. Details of these operations will be discussed below.

Also connected to the Internet 220 is conference room 240 (symbolically represented by people seated around a table). During a meeting in conference room 240 many different clients may be present. Each attendee may have a cellphone, a tablet, a laptop, or other computing device. There may be a projector displaying the desktop of a client in conference room 240 or from some other client from outside conference room 240 (not shown). There may be a VoIP (Voice over Internet Protocol) speaker phone (not shown) carrying a conference call allowing all attendees inside and outside conference room 240 to address the other attendees. All of these connections may be made with a wireless AP 250 coupled with a cable to an Ethernet switch 225 coupled to the Internet 220.

In another location, there may be a plurality of client devices coupled to Internet 220 via another AP 250 and another Ethernet switch 225. Cellphone 260, laptop 270, tablet 280, and smart watch 290 may all be wirelessly connected to different radios using different protocols in the AP 250. In additional embodiments, the AP 250 and Ethernet switch 225 are connected with cables to the Internet 220.

Although a specific embodiment for a network suitable for carrying out the various steps, processes, methods, and operations described herein is discussed with respect to FIG. 2, any of a variety of systems and/or processes may be utilized in accordance with embodiments of the disclosure. For example, the access points may be operated by a network administrator or deployed in a public setting and operated by a centralized administrator or through one or more semi-automated processes. The elements depicted in FIG. 2 may also be interchangeable with other elements of FIGS. 1 and 3A-10 as required to realize a particularly desired embodiment.

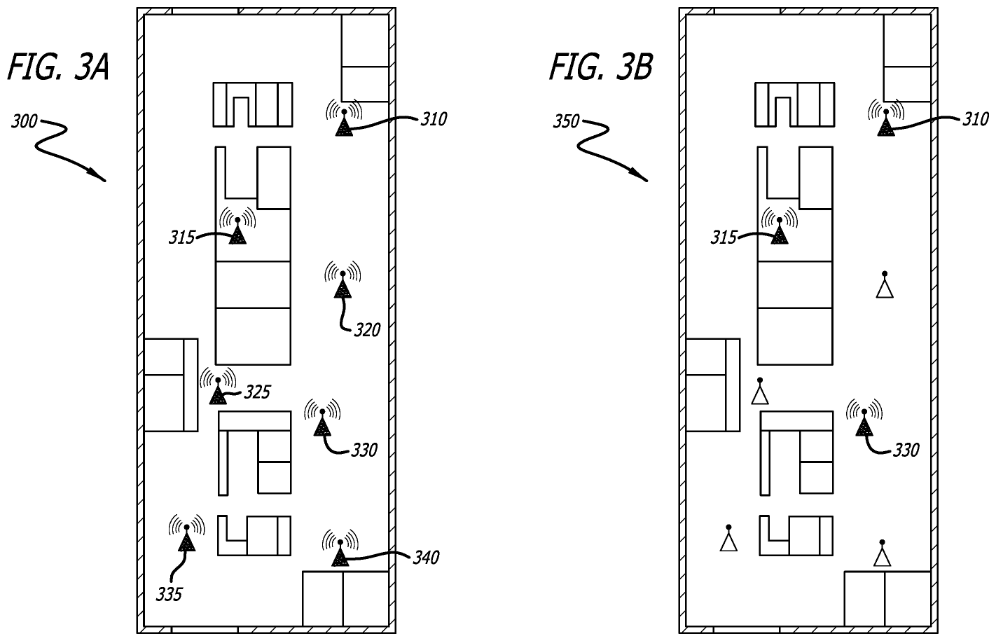

Referring to FIG. 3A, a conceptual illustration of a floorplan 300 with a plurality of access points in accordance with various embodiments of the disclosure is shown. In many embodiments, the floorplan 300 may comprise a number of features like cubicles, offices, conference rooms, etc., represented abstractly with a series of rectangles and other shapes. Also present in the figure are wireless APs 310, 315, 320, 325, 330, 335, and 340 all in operation (as indicated by the arcs radiating from the antenna). This may be an appropriate configuration during the middle of the workday when many people are at their desks working and many of their client devices are active and consuming bandwidth. As conditions in the office change, the activity of the APs may be adjusted accordingly.

Referring to FIG. 3B, a conceptual illustration of a floorplan 350 with a reduced power configuration applied to the plurality of access points in accordance with various embodiments of the disclosure is shown. In additional embodiments, the floorplan 350 may be an appropriate configuration suitable for off-hours when few if any workers are present and most or all of the clients are not present and/or active. Although all seven of the APs from FIG. 3A are still present, only APs 310, 315, and 330 are active while the remaining APs 320, 325, 335, and 340 are inactive or in a low power state. If there is any change in the number and/or activity of the client devices, the new condition may be evaluated, and the activity levels of the various APs may be adjusted. This will be discussed in more detail below.

Although specific embodiments for a floorplan with reduced power configurations suitable for carrying out the various steps, processes, methods, and operations described herein is discussed with respect to FIGS. 3A and 3B, any of a variety of systems and/or processes may be utilized in accordance with embodiments of the disclosure. For example, the floorplans may be in a larger area than a single floorplan or may be partitioned into a portion of a floorplan. The elements depicted in FIGS. 3A and 3B may also be interchangeable with other elements of FIGS. 1-2 and 4-10 as required to realize a particularly desired embodiment.

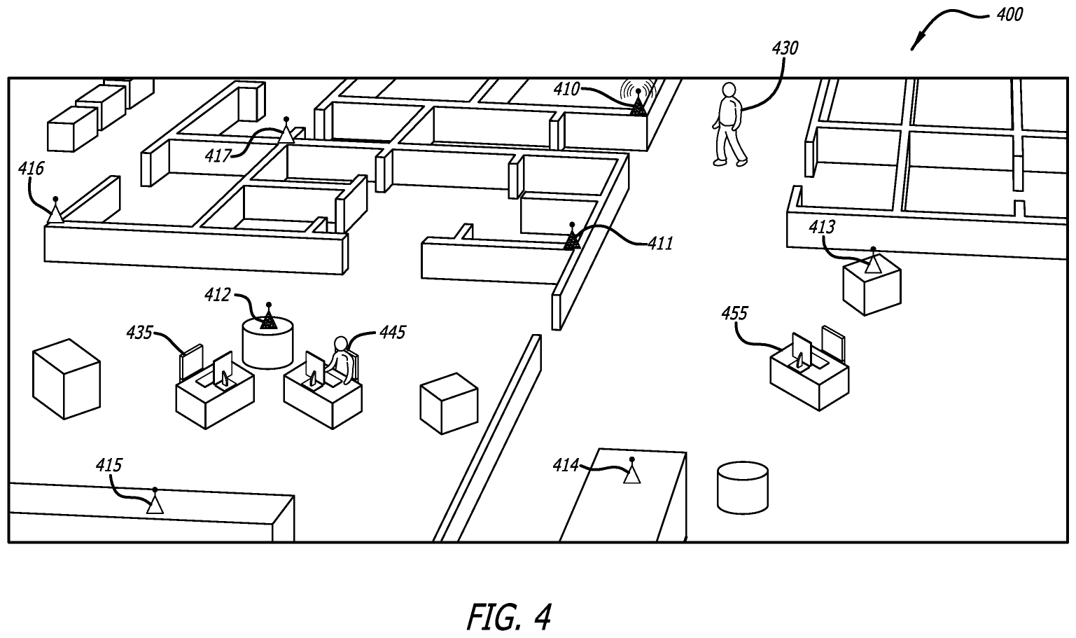

Referring to FIG. 4, a conceptual illustration of a floorplan 400 with a plurality of access points in accordance with various embodiments of the disclosure is shown. In many embodiments, the floorplan 400 may comprise a variety of office structures like partitions and related objects like, for example, workstations 435, 445, and 455. Also present in the embodiment depicted in FIG. 4 are wireless APs 410, 411, 412, 413, 414, 415, 416, and 417. Wireless APs 410, 411, and 412 are shown as active (shaded), while wireless APs 413, 414, 415, 416, and 417 are inactive (no shade). Someone is working at workstation 445 and two of the nearest APs 411 and 412 may be active to provide network coverage.

Worker 430 is shown entering the office area represented by floorplan 400. In various embodiments, worker 430 may have a client device on their person that may have been sensed and caused wireless AP 410 to become active. Other sensors like, for example, motion sensors, may also be utilized. If worker 430 goes to workstation 455 and starts working, a nearby inactive AP like wireless AP 413 may become active to accommodate the additional bandwidth from the client devices that worker 430 may be using. In such a circumstance, wireless AP 410 may become inactive when worker 430 moves farther away. In these embodiments, it is obvious to those skilled in the art that optimal wireless coverage patterns and power settings can change over time.

Although a specific embodiment for a floorplan with a plurality of access points suitable for carrying out the various steps, processes, methods, and operations described herein is discussed with respect to FIG. 4, any of a variety of systems and/or processes may be utilized in accordance with embodiments of the disclosure. For example, the power configurations may change based on predicted usage and not simply reactionary events. The elements depicted in FIG. 4 may also be interchangeable with other elements of FIGS. 1-3B and 5-10 as required to realize a particularly desired embodiment.

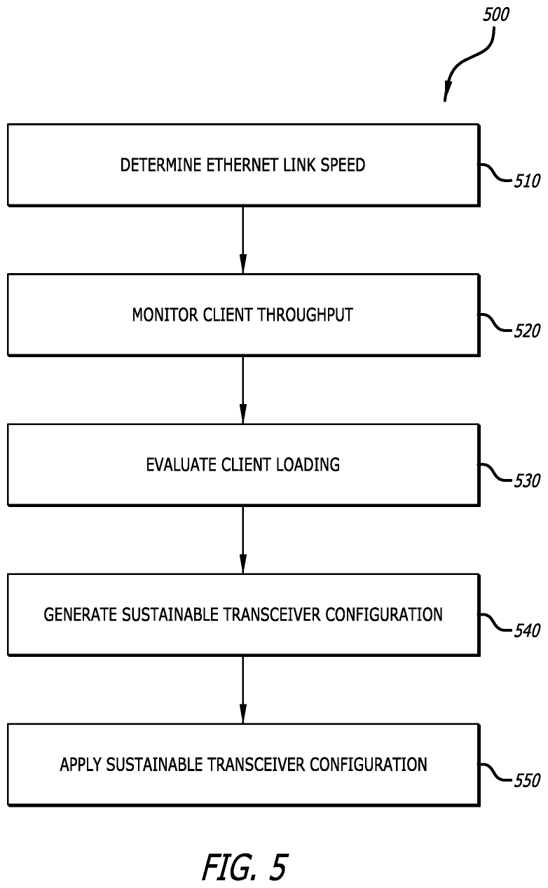

Referring to FIG. 5, a flowchart depicting a process 500 for access point configuration based upon network link speed and client demand in accordance with various embodiments of the disclosure is shown. In many embodiments, process 500 may begin with determining the Ethernet link speed (block 510). In a number of embodiments, this may be negotiated automatically between the switch and the AP. Typically this may be done without concern for sustainability and the lowest maximum frequency of either component becomes the link speed. In a variety of embodiments, the throughput and loading needs of all the client devices wirelessly coupled to that AP are taken into consideration to provide a lower speed connection and thus a more sustainable solution. In further embodiments, the ethernet link speed may be determined in response to the number of associated clients and/or the overall current or expected client throughput.

In some embodiments, the throughput of the various clients wirelessly coupled with the AP may be monitored (block 520). This may entail real-time monitoring of each client and aggregating the total throughput of the group of devices. The total aggregation may change over time and continuous monitoring may be needed.

In more embodiments, the loading of the AP by individual client devices may be performed (block 530). This may include monitoring the power consumption and throughput but may include the particular bands, radio(s), and radio chains. (In networking, a radio chain may refer to a set of components that may be used in wireless communication systems to transmit and receive radio signals. In these systems, multiple radio chains are used to provide coverage over a large area and to handle multiple connections simultaneously.) In additional embodiments, the particular bands, radio(s), and radio chains being utilized may be used to aggregate and/or optimize the usage of the various radio(s)/radio chains. The inspected client throughput may be compared to one or more predetermined thresholds (e.g., the total available client throughput), and transceivers or radio chains may be shut down based on a first predetermined threshold or powered up based on a second predetermined threshold. In still more embodiments, the number of client associated with the access point can be utilized to compare to one or more predetermined thresholds. In additional embodiments, the total speed of the transceivers may be used.

In further embodiments, a sustainable transceiver configuration may be generated (block 540). This may be an optimization of the current state of the particular bands, and radios and/or chains being utilized. In still more embodiments, different signals may be moved from one radio band to another. Ideally, all the radio chains on one radio may be moved to another, which may allow the unused radio to be put into a lower power state or be powered off completely until needed. The optimized configuration may be applied to the appropriate transceivers (block 550) in the AP.

In still further embodiments, the ordering of these steps may be different. Persons skilled in the art will appreciate that the steps may be in another order, or some steps may be done in parallel rather than in an entirely sequential ordering as a matter of design choice.

Although a specific embodiment for a process for access point configuration based upon network link speed and client demand suitable for carrying out the various steps, processes, methods, and operations described herein is discussed with respect to FIG. 5, any of a variety of systems and/or processes may be utilized in accordance with embodiments of the disclosure. For example, an Ethernet switch may be coupled to a wireless access point. The switch and the AP may agree on a 1 Gps (Gigabits Per Second) link speed, and then the AP may evaluate the loading of the connected clients and may produce a sustainable configuration which may then be applied to the transceivers. The elements depicted in FIG. 5 may also be interchangeable with other elements of FIGS. 1-4 and 6-10 as required to realize a particularly desired embodiment.

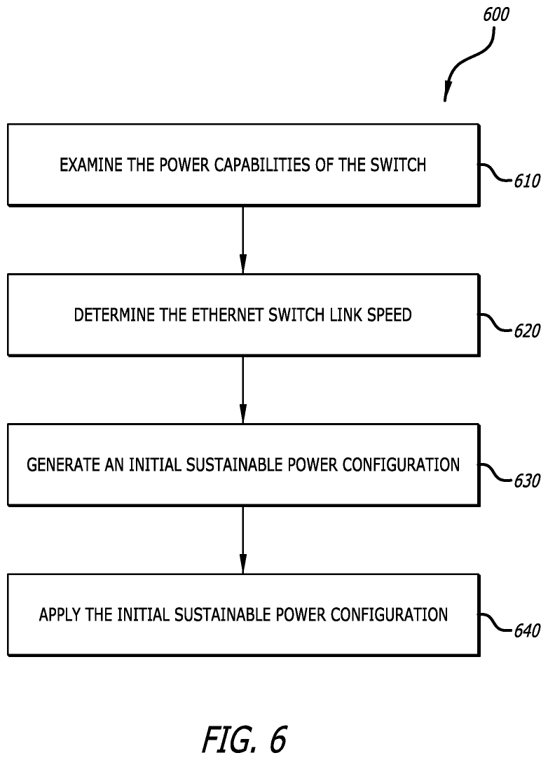

Referring to FIG. 6, a flowchart depicting a process 600 for access point configuration based upon network link speed and client demand in accordance with various embodiments of the disclosure is shown. In many embodiments, process 600 may begin with examining the power capabilities of a network switch coupled to an AP (block 610). Network switches can provide a number of capabilities beyond Ethernet connectivity. For example, some devices can provide Power over Ethernet (POE) to energize devices that have no other power connection. In a number of embodiments, the AP may receive its power this way.

In a variety of embodiments, the Ethernet connection speed from the switch to an AP may be determined (block 620). This may be automatically negotiated between the switch and the AP; it may include information about the available throughput capability of the Ethernet link as well as the current power needs of the AP.

This can be used to generate an initial sustainable power configuration for the AP which may be determined using a look up table to set the AP configuration (block 630) or by some other method. The initial sustainable power configuration may then be applied (block 640).

In some embodiments, the ordering of these steps may be different. Persons skilled in the art will appreciate that the steps may be performed in another order, or some steps may be done in parallel rather than in an entirely sequential ordering as a matter of design choice.

Although a specific embodiment for a process for access point configuration based upon network link speed and client demand suitable for carrying out the various steps, processes, methods, and operations described herein is discussed with respect to FIG. 6, any of a variety of systems and/or processes may be utilized in accordance with embodiments of the disclosure. For example, an Ethernet switch with PoE+ (2× power of PoE) power delivery capability may provide power and communication to a wireless AP via an Ethernet cable where a link speed of 1 Gbs may be set by a look-up table and/or negotiated, and sustainable power configurations are determined. The elements depicted in FIG. 6 may also be interchangeable with other elements of FIGS. 1-5 and 7-10 as required to realize a particularly desired embodiment.

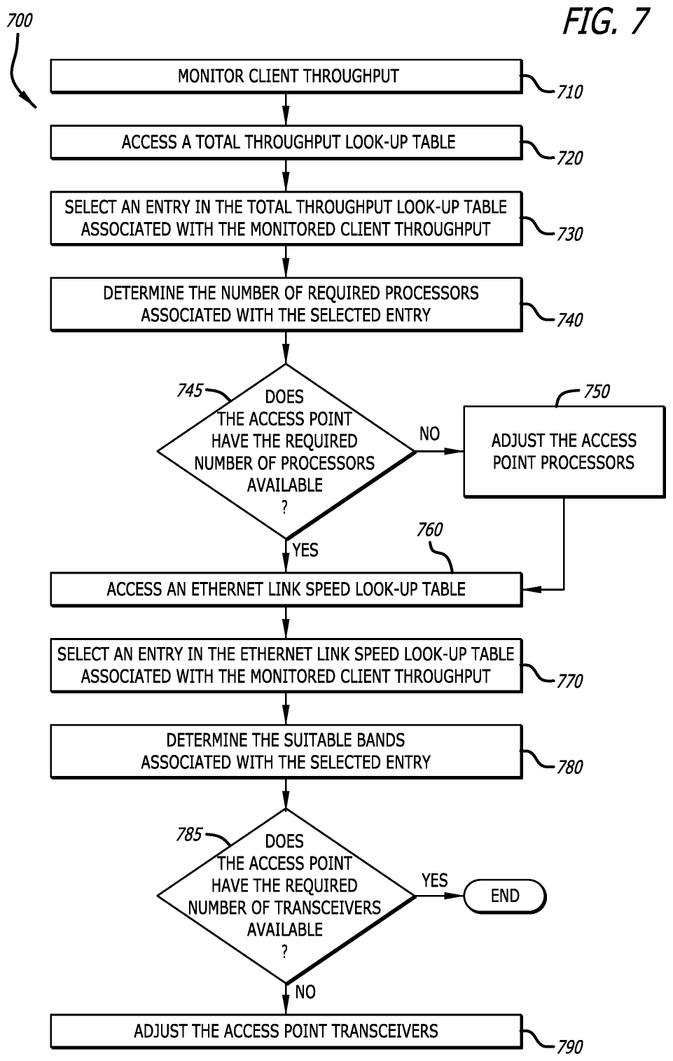

Referring to FIG. 7, a flowchart depicting a process 700 for access point configuration based upon network link speed and client demand in accordance with various embodiments of the disclosure is shown. In many embodiments, process 700 may begin with monitoring the client throughput of a wireless access point (block 710). Each client has an associated throughput, and inspecting the AP may result in a total throughput of all the wireless clients communicating with the AP. In a number of embodiments, a throughput look-up table may be accessed (block 720). This may consist of a predetermined configuration for each throughput range of the cumulative client devices. This may include the frequency bands/chains, the power state of radios, the associated number of processors, etc. An appropriate entry may be selected from the table.

In a variety of embodiments, a required number of processors in the AP may be associated with the throughput look-up table entry selection (block 730). One purpose of the AP may be to translate between the various wireless technologies that clients may use and the negotiated Ethernet link speed. This may require computing power, and a certain number of processors in the AP may be determined to power up to meet the computational demands of the throughput (block 740).

In some embodiments, it may be determined if the AP has the necessary number of processors available (block 745). If not, the access point processors may be adjusted (block 750), which may be followed by accessing an Ethernet link speed look-up table (block 760).

If so, an Ethernet link speed look-up table associated with the monitored client throughput may be accessed (block 760). For maximum efficiency and lowest power, the available Ethernet connection speed may be matched to the collective client device throughput (block 770). In additional embodiments, it may be determined what a suitable mixture of frequency bands on the AP may be for the selected Ethernet link speed (block 780). This may indicate a more efficient combination of radios and/or radio bands for the needed throughput.

In further embodiments, it may be determined if the AP has a sufficient quantity of transceivers available (block 785). If so, then the process 700 may end. If not, the AP transceiver settings, such as, but not limited to, bands, may be adjusted to the more efficient configuration in the look-up table entry (block 790).

Although a specific embodiment for a process for access point configuration based upon network link speed and client demand suitable for carrying out the various steps, processes, methods, and operations described herein is discussed with respect to FIG. 7, any of a variety of systems and/or processes may be utilized in accordance with embodiments of the disclosure. For example, an Ethernet switch with PoE power delivery capability may provide power and communication to a wireless AP via an Ethernet cable. A link speed of 1 Gbs and an efficient mix of wireless band usage, processor usage, and sustainable power configurations may be determined by successive applications of look-up tables. The elements depicted in FIG. 7 may also be interchangeable with other elements of FIGS. 1-6 and 8-10 as required to realize a particularly desired embodiment.

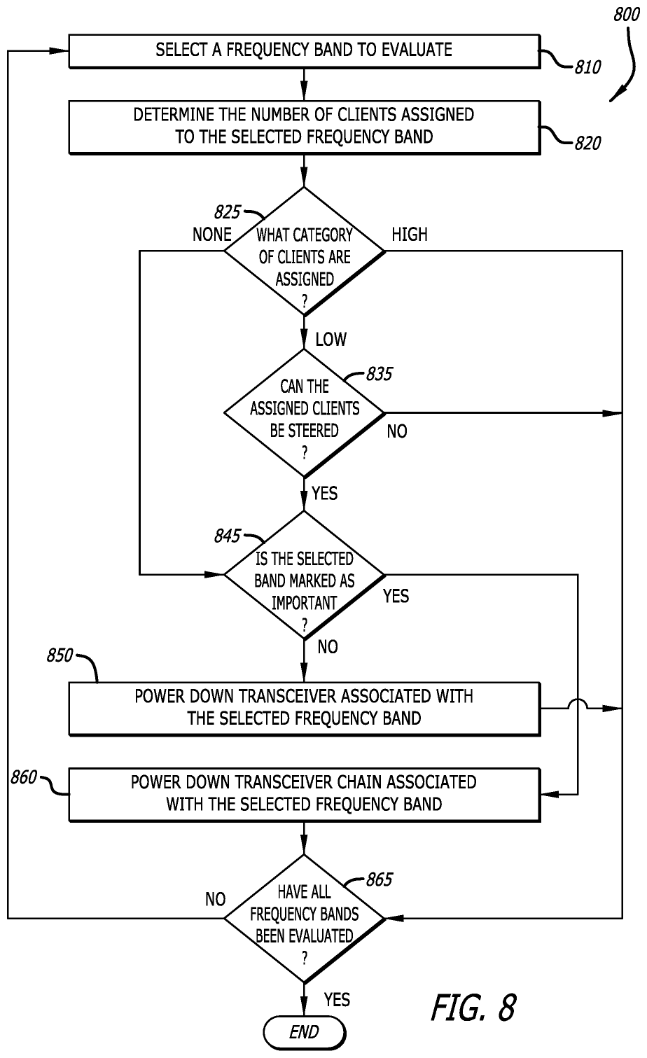

Referring to FIG. 8, a flowchart depicting a process 800 for access point configuration based upon network link speed and client demand in accordance with various embodiments of the disclosure is shown. In many embodiments, process 800 may begin by selecting a frequency band to evaluate (block 810). The frequency (or energy) band may be one of several of which a wireless access point is capable of. For example, many wireless APs support 2.4 GHz wireless transceivers, 5 GHz wireless transceivers, and 6 GHz wireless transceivers. In a number of embodiments, other technologies such as Bluetooth or cellular communications standards like 3G, 4G, and 5G may be supported.

In further embodiments, the number of clients assigned to the selected frequency band may be determined (block 820). The priority of clients may be categorized as high importance, low importance, and/or no importance (e.g., no clients on this frequency band). This may determine the resources that are allocated to them. A determination of the category of clients for the selected frequency band is made (block 825).

In additional embodiments, if the clients are categorized as high importance, no further changes are made to the selected frequency band. A determination is made if all frequency bands have been evaluated (block 865). If yes, process 800 may end. If not, a new frequency band may be selected for evaluation (block 810).

In more embodiments, if the clients are categorized as none (e.g., no clients on this frequency band), a determination of the importance of the band may be made (block 845). If the band is marked as important, one or more transceiver chains may be powered down (block 860), and a determination is made if all frequency bands have been evaluated (block 865). If the band is marked as unimportant then the entire transceiver for that band is powered down (block 850), and a determination is made if all frequency bands have been evaluated (block 865).

In some embodiments, if the clients are categorized as low importance, a determination if the clients may be steered to another band may be made (block 835). If so, then a determination of the importance of the band may be made (block 845). If not, a determination is made if all frequency bands have been evaluated (block 865).

In some more embodiments, the sort of sieve (blocks 825, 835, and 845) illustrated in FIG. 8 may be used to keep important bands active with reductions in the number of transceiver chains used if possible. Transceiver chains may comprise a portion of a transceiver's bandwidth, so reducing the number of chains reduces the power consumption of the transceiver by only using a portion of its bandwidth. If a band is unimportant, then its transceiver may be completely shut down if the low priority clients can be moved to another band.

Although a specific embodiment for a process for access point configuration based upon network link speed and client demand suitable for carrying out the various steps, processes, methods, and operations described herein is discussed with respect to FIG. 8, any of a variety of systems and/or processes may be utilized in accordance with embodiments of the disclosure. For example, an Ethernet switch with PoE power delivery capability may provide power and communication to a wireless AP via an Ethernet cable with a link speed of 1 Gbs. The AP may support multiple frequency bands with multiple client priorities. A sieve may be used to optimally choose which frequency bands and transceiver chains are to be made active. When complete, process 800 may be rerun at any time to continuously keep the entire system as sustainable as possible. The elements depicted in FIG. 8 may also be interchangeable with other elements of FIGS. 1-7 and 9-10 as required to realize a particularly desired embodiment.

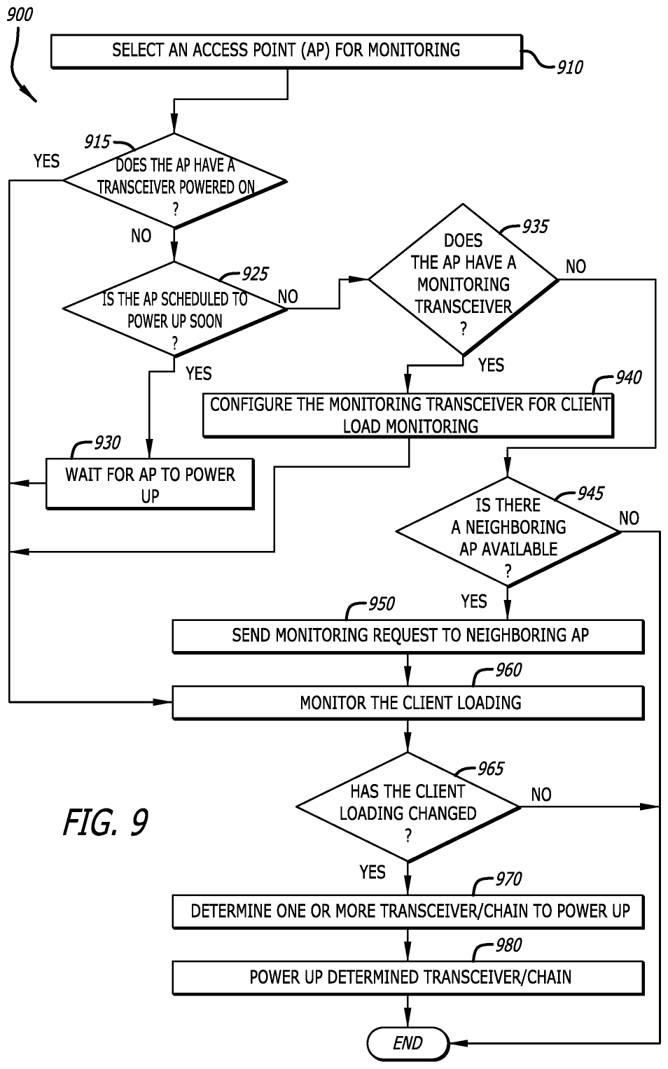

Referring to FIG. 9, a flowchart depicting a process 900 for access point configuration based upon network link speed and client demand in accordance with various embodiments of the disclosure is shown. In many embodiments, process 900 may begin by selecting an access point for monitoring (block 910). The AP may be coupled to an Ethernet switch by a cable which allows communication and may provide power to the AP (e.g., with PoE). A determination may be made if the AP has a transceiver powered on (block 915). If a transceiver is on, then the client loading may be monitored (block 960).

In several embodiments, a determination may be made as to whether the client loading has changed since the last monitoring event (block 965). If no change in the client loading has occurred, process 900 may end. If there has been a change, one or more transceivers and/or transceiver chains may be selected to power up (block 970). The selected transceivers and/or chain may be powered up (block 980) and process 900 may end. In several more embodiments, if the client loading has decreased then transceivers and/or transceiver chains may be lowered in power or powered off (not shown in the figure).

As discussed above, a determination may be made if the AP has a transceiver powered on (block 915). In further embodiments, if no transceiver is on, a determination is made as to whether the AP is scheduled to power up soon (block 925). The time period of “soon” is a matter of design choice by either the AP manufacturer and/or the network administrator of the network in which the AP is deployed. If the AP is scheduled to power up soon, the network will wait until the AP is powered up (block 930) and then monitor the client loading (block 960).

In various embodiments, if the AP is not scheduled to power up soon, then a determination is made whether the AP is equipped with a monitoring transceiver (block 935). A monitoring transceiver may be a specialized device or component used for monitoring and analyzing wireless network traffic. It may be designed to capture wireless signals and provide detailed information about the network performance, quality, and other metrics. If the AP has a monitoring transceiver, the monitoring transceiver may be configured for client load monitoring (block 940), and the client loading may be monitored (block 960).

In certain embodiments, if the AP does not have a monitoring transceiver a determination is made with respect to the availability of a neighboring AP (block 945). If there is no neighboring AP, then process 900 may end. If there is a neighboring AP, then a monitoring request may be sent to the neighboring AP (block 950), and the client loading may be monitored (block 960). Since networks may be provisioned with excess capacity to ensure that service-level agreements (SLAs) are met, there may often overlaps between the areas covered by neighboring APs. Typically, these APs will have the same capabilities, so the neighboring AP can “listen” to the network traffic and monitor its neighbor's bandwidth usage.

Although a specific embodiment for a process for access point configuration based upon network link speed and client demand suitable for carrying out the various steps, processes, methods, and operations described herein is discussed with respect to FIG. 9, any of a variety of systems and/or processes may be utilized in accordance with embodiments of the disclosure. For example, an Ethernet switch with PoE power delivery capability may provide power and communication to one or more wireless APs via an Ethernet cables with a link speed of 1 Gbs. The APs may monitor themselves and/or their neighbors. In additional embodiments, the APs may have monitoring transceivers which may be used to monitor themselves and/or their neighbors. When complete, process 900 may be rerun at any time to continuously keep the entire system as sustainable as possible. The elements depicted in FIG. 9 may also be interchangeable with other elements of FIGS. 1-8 and 10 as required to realize a particularly desired embodiment.

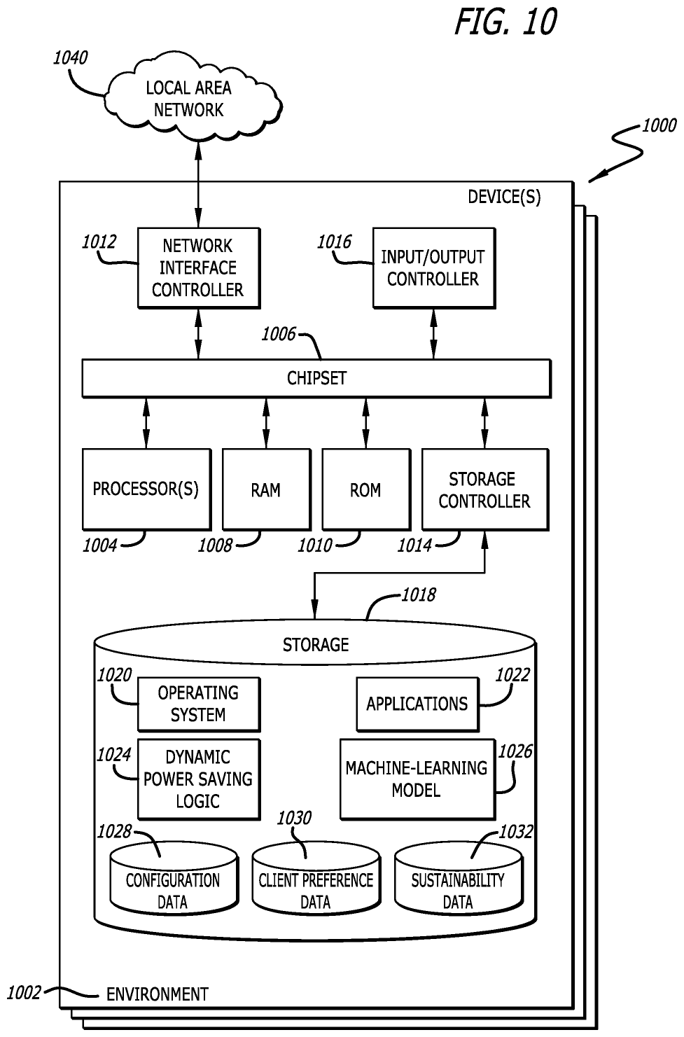

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing device, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10, or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a dynamic power saving logic (DPSL) 1024. DPSL 1024 may be where the overall sustainable power logic is performed. This functionality may be distributed between DPSL 1024 and the Ethernet switches and wireless APs coupled to device 1000. DPSL 1024 may determine the Ethernet link speed by means of an Ethernet handshake, an analysis of the clients coupled with the AP, or by means of a look-up table. These different methods may be used at different times like, for example, at power on for the Ethernet switch or AP, periodically to check for changes to the client loading, at handoffs between different APs in the network, etc.

In yet more embodiments, DPSL 1024 may determine the number of processors being used in either the Ethernet switch or the AP. Translating between various wireless technologies like Wi-Fi 2.4/5/6 Gbs, cellular data, Bluetooth, etc., and Ethernet may require compute capability. This may be determined based upon the wireless throughput at the AP to get the most sustainable configuration in terms of number of processors and/or the speed/power settings on the processors themselves.

In some more embodiments, DPSL 1024 may evaluate the usage of frequency bands at the AP. Determinations may be made concerning the priority of frequency bands and/or users, and these may result in clients being steered efficiently to appropriate frequency bands, powering up or down transceivers and/or transceiver chains.

In still yet more embodiments, DPSL 1024 may select an access point for monitoring. If the AP has a transceiver powered on, then it may be monitored for client loading to determine if the client loading has changed. If so, then one or more transceivers and/or transceiver chains may be powered up or down as appropriate the changed state of the loading. In still additional embodiments, DPSL 1024 may utilize a monitoring transceiver in the AP if one is available. In yet additional embodiments, DPSL 1024 may request a neighboring AP to monitor the selected AP.

In a number of embodiments, the storage 1018 can include configuration data 1028. Configuration data 1028 may comprise information needed for DPSL 1024 to perform its functions. This may include various look-up tables with configuration information for both the Ethernet switch and the AP, various transceiver configurations including operation with various technologies, information about the wireless network as a whole including the physical locations of the various APs and the overlaps between their coverage areas, etc.

In various embodiments, the storage 1018 can include client preference data 1030. Client preference data 1030 may comprise information related to the priorities given to various preferred frequency (e.g., preferred energy bands) in particular technologies and how to manage clients coupled to APs. This data may be provided directly by a network administrator or may be dynamically generated by a set of heuristics or one or more machine learning processes/models.

In still more embodiments, the storage 1018 can include sustainability data 1032. Sustainability data 1032 may comprise data related to the power consumption of Ethernet switches and AP, the power consumption of various transceivers, the power consumption of Ethernet connections, etc. If there is a choice of power source, there may also be information as to which sources is more sustainable.

Finally, in many more embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

In further embodiments, ML model 1026 may learn the patterns of client usage and anticipate changes in throughput at any AP. Thus, the Ethernet switches and APs may respond more nimbly to changes. In yet further embodiments, ML model 1026 may manage the usage of the APs by the various clients. Clients may be distributed across overlapping APs to provide a more sustainable configuration overall than might be possible with each Ethernet switch and AP separately negotiating a local minimum configuration separately.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor;
a network interface controller configured to be in communication with a network switch via an ethernet connection;
a plurality of transceivers configured to provide wireless network access to a plurality of clients wherein each of the plurality of clients has an associated throughput; and
a dynamic power saving logic, configured to:
determine an ethernet connection speed;
adjust the plurality of device transceivers in response to the determined ethernet connection speed;
inspect the client throughput for each of the plurality of clients;
compare the inspected client throughput against a first predetermined threshold; and
shut down a transceiver, in response to the inspected client throughput being below the first predetermined threshold.

2. The device of claim 1, wherein the ethernet connection speed is a negotiated ethernet link speed between the device and the network switch.

3. The device of claim 2, wherein the dynamic power saving logic is further configured to:
access a total speed of the plurality of transceivers; and
compare the negotiated ethernet link speed against the total speed of the plurality of transceivers.

4. The device of claim 3, wherein the adjustment of the plurality of device transceivers comprises powering down one or more of the transceivers in response to the negotiated ethernet link speed being less than the total speed of the plurality of transceivers.

5. The device of claim 4, wherein the adjustment of the plurality of device transceivers is also based on client preference data.

6. The device of claim 5, wherein the client preference data comprises at least one preferred energy band of wireless network connection.

7. The device of claim 1, wherein determining the ethernet connection speed is based on at least a number of associated clients or the client throughput.

8. The device of claim 1, wherein the dynamic power saving logic is further configured to shut down a processor, in response to the inspected client throughput being below the first predetermined threshold.

9. The device of claim 8, wherein the first predetermined threshold is determined by accessing a look-up table.

10. The device of claim 9, wherein the look-up table contains a plurality of entries associated with the inspected client throughput.

11. The device of claim 10, wherein the plurality of entries within the look-up table has an associated number of processors to operate.

12. The device of claim 1, wherein the dynamic power saving logic is further configured to:
monitor the plurality of clients being provided wireless network access;
compare the monitored plurality of clients against a second predetermined threshold; and
power on a transceiver, in response to the monitored plurality of clients exceeding the second predetermined threshold.

13. A method of sustainably managing an access point, comprising:
determining an ethernet connection speed between the access point and a network switch connected to the access point via an ethernet connection;
adjusting a plurality of device transceivers associate with the access point in response to the determined ethernet connection speed;
determining a plurality of clients connected to the access point;
inspecting a client throughput for each of the plurality of clients;
comparing the inspected client throughput against a first predetermined threshold; and
adjusting a transceiver, in response to the inspected client throughput being below the first predetermined threshold.

14. A device, comprising:
a processor;
a memory communicatively coupled to the processor;
a network interface controller configured to be in communication with a network switch via an ethernet connection;
a plurality of device transceivers configured to provide wireless network access to a plurality of clients across one or more frequency bands wherein each of the plurality of clients has an associated throughput; and
a dynamic power saving logic, configured to:
determine an ethernet connection speed;
adjust the plurality of device transceivers in response to the determined ethernet connection speed;
inspect the client throughput for each of the plurality of clients on one or more of the frequency bands; and
adjust the plurality of transceivers based on the inspected client throughput across the one or more frequency bands.

15. The device of claim 14, wherein the adjustment of the plurality of transceivers includes powering off the frequency band in response to each of the inspected plurality of clients not utilizing the frequency band.

16. The device of claim 15, wherein the dynamic power saving logic is further configured to:
access client preference data associated with the frequency band; and
retain power to the frequency band based on the accessed client preference data.

17. The device of claim 14, wherein the dynamic power saving logic is further configured to:
steer one or more clients associated with the frequency band toward a different frequency band; and
power off the frequency band in response to the steering of the associated clients being completed.

18. The device of claim 17, wherein the dynamic power saving logic is further configured to:
access client preference data associated with the frequency band; and
retain power to the frequency band based on the accessed client preference data.

19. The device of claim 18, wherein the steering of the one or more clients associated with the frequency band occurs in response to a number of clients associated with the frequency band is below a third predetermined threshold.

20. The device of claim 19, wherein the steering of the one or more clients occurs across a second device, such that the frequency band of the one or more clients is retained when steered to the second device.
